(19) United States
(12) Patent Application Publication
(10) Pub. No.: US 2011/0142500 A1
(43) Pub. Date: Jun. 16, 2011

(54) DEVELOPING DEVICE, DEVELOPING METHOD AND IMAGE FORMING APPARATUS

(75) Inventor: Koichiro Sato, Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/952,802

(22) Filed: Nov. 23, 2010

Related U.S. Application Data
(60) Provisional application No. 61/285,418, filed on Dec. 10, 2009.

(51) Int. Cl. G03G 15/09

(52) U.S. Cl. 399/274

(57) ABSTRACT

According to an embodiment, a developing device includes: a rotatable developing roller which has plural magnets forming magnetic poles; and a regulating member which includes a non-magnetic plate and a magnetic plate extending parallel to an axial direction of the developing roller and arranged facing the developing roller to regulate thickness of a developer layer on the developing roller, the magnetic plate being attached to a central part in the longitudinal direction of the non-magnetic plate to form a magnetic chain between the developing roller and the regulating member stronger at the central part than an end part.

### CROSS-REFERENCE TO RELATED APPLICATION

This application is based upon and claims the priority of U.S. Provisional Application No. 61/285,418, filed on Dec. 10, 2009, the entire contents of which are incorporated herein by reference.

### FIELD

Embodiments described herein relate generally to a developing device including a regulating member which regulates thickness of a developer layer, a developing method and an image forming apparatus.

### BACKGROUND

In an image forming apparatus such as an electrographic copier, an image is formed on a sheet in a cycle of charging, exposure, development, transfer and so on. For example, the surface of a photoconductive drum is uniformly charged. The charged photoconductive drum is irradiated with a laser beam to form an electrostatic latent image. The electrostatic latent image on the photoconductive drum is developed by the developing unit to form a toner image.

The toner image on the photoconductive drum is primary-transferred to an intermediate transfer belt or the like that is turning. The toner image is then secondary-transferred onto a sheet. The sheet having the toner image secondary-transferred thereto is heated by a fixing unit and the toner image is thus fixed to the sheet. The sheet having the toner image fixed thereto is discharged by a carrying roller.

The developing unit has a developing roller which faces the photoconductive drum. The developing roller includes plural magnets at fixed positions and a sleeve that is supported rotatably on the outer circumference of the magnets. Also a regulating member is provided in order to regulate the thickness of a developer layer on the surface of the developing roller.

The regulating member has a structure in which a magnetic plate is attached to a non-magnetic plate provided parallel to the axial direction of the developing roller. The regulating member is arranged at a preset distance to the developing roller. Therefore, a magnetic chain is formed between the magnets within the developing roller and the regulating member. The thickness of the developer layer is decided on the basis of the rotating force of the developing roller and the strength of the magnetic chain.

The developer layer on the developing roller tends to be thicker at a central part in the longitudinal direction of the developing roller. A developer layer that is too thick at the central part causes reduction in the density of the developer and causes uneven density. Also, the developer passing through the nip between the photoconductive drum and the developing roller receives an excessive shear stress and thus generates heat. Thus, the filming phenomenon of the toner material adhering to the photoconductive drum occurs.

The cause of the increased thickness of the developer layer at the central part in the longitudinal direction of the developing roller is considered to be the fact that as the developing roller rotates, the central part in the longitudinal direction of the regulating member is pushed by the developer and therefore flexes, and consequently increases the distance between the regulating member and the surface of the developing roller at the center in the axial direction.

### BRIEF DESCRIPTION OF THE DRAWINGS

FIG. 1 shows the overall configuration of an image forming apparatus according to an embodiment.

FIG. 2 is an enlarged view showing the configuration of image forming units used in the image forming apparatus according to the embodiment.

FIG. 3 is an enlarged view showing the configuration of one of the image forming units.

FIG. 4 is a perspective view schematically showing a regulating member which regulates the thickness of a developer layer.

FIG. 5 is an explanatory view showing the regulation of the thickness of the developer layer by the regulating member.

FIG. 6 is a perspective view showing a first configuration of the regulating member.

FIG. 7 is a perspective view showing a second configuration of the regulating member.

FIG. 8 is a perspective view showing a third configuration of the regulating member.

FIG. 9 is a perspective view showing a fourth configuration of the regulating member.

FIG. 10 is a front view of the regulating member shown in FIG. 6 and a developing roller.

FIG. 11 is an explanatory view showing the strength of a magnetic chain in the case of a thin magnetic member.

FIG. 12 is a graph showing the results of an experiment where the thickness of the regulating member is changed.

### DETAILED DESCRIPTION

According to an embodiment, a developing device includes:

a rotatable developing roller which has plural magnets forming magnetic poles; and

a regulating member which includes a non-magnetic plate and a magnetic plate extending parallel to an axial direction of the developing roller and arranged facing the developing roller to regulate thickness of a developer layer on the developing roller, the magnetic plate being attached to a central part in the longitudinal direction of the non-magnetic plate to form a magnetic chain between the developing roller and the regulating member stronger at the central part than an end part.

Hereinafter, an image forming apparatus according to an embodiment will be described in detail with reference to the drawings. In the drawings, the same parts are denoted by the same reference numerals.

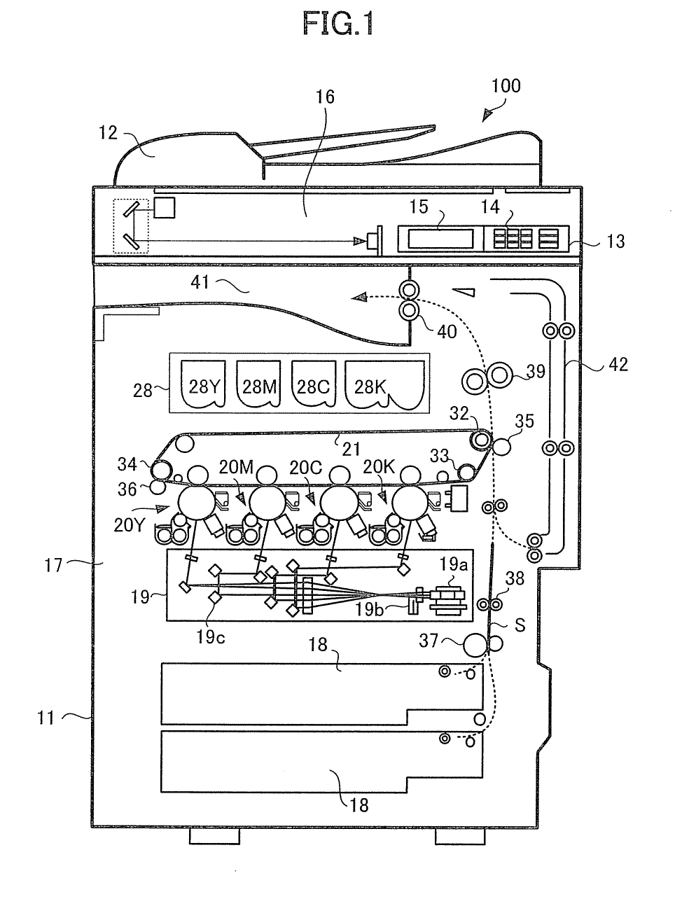

FIG. 1 shows the configuration of an image forming apparatus having a developing device according to an embodiment. In FIG. 1, an image forming apparatus 100 is, for example, a multi-function peripheral (MFP), printer, copier or the like. Hereinafter, an example using an MFP is will be described.

There is a document table on top of a body 11 of the MFP 100. An automatic document feeder (ADF) 12 is provided on the document table in such a manner that the ADF 12 can open and close freely. An operation panel 13 is provided in an upper part of the body 11. The operation panel 13 has an operation unit 14 including various keys, and a touch panel display unit 15.

A scanner unit 16 is provided in the body 11 below the ADF 12. The scanner unit 16 scans a document fed by the ADF 12 or a document placed on the document table, and generates image data. A printer unit 17 is provided in a central part in the body 11. Plural cassettes 18 housing sheets of various sizes are provided in a lower part of the body 11.

The printer unit 17 includes a photoconductive drum, laser and the like. The printer unit 17 processes image data scanned by the scanner unit 16 or image data created by a personal computer (PC) or the like, and forms an image on a sheet (which will be described in detail later). The printer unit 17 is, for example, tandem color laser printer, in which a photoconductive member is scanned with a laser beam from an optical scanning device (laser unit) 19 and an image is thus generated.

The printer unit 17 includes image forming units 20Y, 20M, 20C and 20K for the colors of yellow (Y), magenta (M), cyan (C) and black (K). The image forming units 20Y, 20M, 20C and 20K are arranged in parallel along a path from upstream to downstream, below an intermediate transfer belt 21.

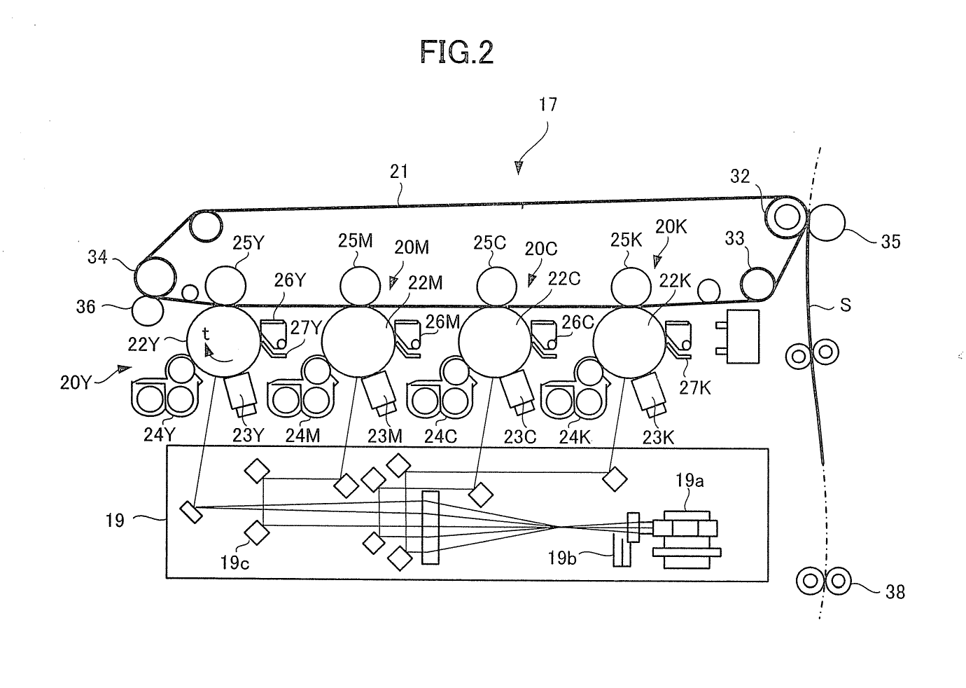

FIG. 2 shows an enlarged view of the printer unit 17 including the image forming units 20Y, 20M, 20C and 20K. In the following description, the image forming unit 20Y will be described as a representative example because the image forming units 20Y, 20M, 20C and 20K have the same configuration.

As shown in FIG. 2, the image forming unit 20Y has a photoconductive drum 22Y as an image carrier. Around the photoconductive drum 22Y, a charger 23Y, a developing unit 24Y, a primary transfer roller 25Y, a cleaner 26Y, a blade 27Y and the like are arranged along a direction of rotation t. A yellow laser beam from the optical scanning device 19 is cast to an exposure position on the photoconductive drum 22Y and an electrostatic latent image is thus formed on the photoconductive drum 22Y.

The charger 23Y in the image forming unit 20Y uniformly charges the entire surface of the photoconductive drum 22Y. The developing unit 24Y, with a developing roller 24a, supplies a two-component developer containing a yellow toner and a carrier to the photoconductive drum 22Y. The cleaner 26Y uses the blade 27Y to remove residual toner from the surface of the photoconductive drum 22Y.

As shown in FIG. 1, a toner cartridge 28 which supplies toners to the developing units 24Y to 24K is provided above the image forming units 20Y to 20K. The toner cartridge 28 includes toner cartridges (28Y, 28M, 28C and 28K) for the colors of yellow (Y), magenta (M), cyan (C) and black (K).

The intermediate transfer belt 21 moves circularly. For example, semi-conductive polyimide is used for the intermediate transfer belt 21 in view of the heat resistance and wear resistance. The intermediate transfer belt 21 is stretched over a driving roller 32 and driven rollers 33 and 34. The intermediate transfer belt 21 faces and contacts the photoconductive drums 22Y to 22K. At a position on the intermediate transfer belt 21 that faces the photoconductive drum 22Y, a primary transfer voltage is applied by the primary transfer roller 25Y and the toner image on the photoconductive drum 22Y is primary-transferred to the intermediate transfer belt 21.

A secondary transfer roller 35 is arranged facing the driving roller 32, which stretches the intermediate transfer belt 21. When a sheet S passes between the driving roller 32 and the secondary transfer roller 35, a secondary transfer voltage is applied by the secondary transfer roller 35 and the toner image on the intermediate transfer belt 21 is secondary-transferred to the sheet S. A belt cleaner 36 is provided near the driven roller 34 on the intermediate transfer belt 21.

The optical scanning device 19 scans the photoconductive drum 22 in the axial direction with a laser beam emitted from a semiconductor laser element. The optical scanning device 19 includes a polygon mirror 19a, an imaging lens system 19b, a mirror 19c and the like.

As shown in FIG. 1, a separation roller 37 which takes out the sheet S from the paper supply cassettes 18, and a carrying roller 38 are provided in the path from the paper supply cassettes 18 to the secondary transfer roller 35. A fixing unit 39 is provided downstream of the secondary transfer roller 35. A carrying roller 40 is provided downstream of the fixing unit 39. The sheet S is carried by the carrying roller 40 and discharged to a paper discharge unit 41.

Moreover, a reverse carrying path 42 is provided downstream of the fixing unit 39. The reverse carrying path 42 is for reversing the sheet S and then guiding the sheet S toward the secondary transfer roller 35. The reverse carrying path 42 is used for double-side printing.

A finisher may be arranged near the image forming apparatus 100. In the image forming apparatus 100 that is connectable to the finisher, another carrying roller is provided downstream of the carrying roller 40 so that sheet S is discharged toward the finisher. The finisher staples or punches the sheet, then folds the sheets into two and discharges the sheet.

Next, the operation of the image forming apparatus 100 shown in FIG. 1 and FIG. 2 will be described. When image data is inputted from the scanner unit 16 or a PC, the image forming units 20Y to 20K sequentially form images.

An example using the image forming unit 20Y will now be described. The photoconductive drum 22Y is irradiated with a laser beam corresponding to yellow (Y) image data, and an electrostatic latent image is formed. The electrostatic latent image on the photoconductive drum 22Y is developed by the developing unit 24Y and a yellow (Y) toner image is formed.

The photoconductive drum 22Y contacts the turning intermediate transfer belt 21, and the yellow (Y) toner image is primary-transferred onto the intermediate transfer belt 21 by the primary transfer roller 25Y. After the toner image is primary-transferred to the intermediate transfer belt 21, the residual toner on the photoconductive drum 22Y is removed by the cleaner 26Y and the blade 27Y. The next image formation is available then.

Similarly to the yellow (Y) toner image formation, magenta (M), cyan (C) and black (K) toner images are formed by the image forming units 20M to 20K. The toner images are sequentially transferred to the same position as the yellow (Y) toner image on the intermediate transfer belt 21. The yellow (Y), magenta (M), cyan (C) and black (K) toner images are multiple-transferred onto the intermediate transfer belt 21. A full-color toner image is thus acquired.

The intermediate transfer belt 21 collectively secondary-transfers the full-color toner image onto the sheet S, using a transfer bias of the secondary transfer roller 35. The sheet S is supplied from the paper supply cassette 18 to the secondary transfer roller 35, synchronously with the arrival of the full-color toner image on the intermediate transfer belt 21 at the secondary transfer roller 35.

The sheet S having the toner image secondary-transferred thereto reaches the fixing unit 39, and the toner image is fixed. The sheet S having the toner image fixed thereto is discharged to the paper discharge unit 41 by the carrying roller 40. After the secondary transfer, the residual toner on the intermediate transfer belt 21 is cleaned by the belt cleaner 36.

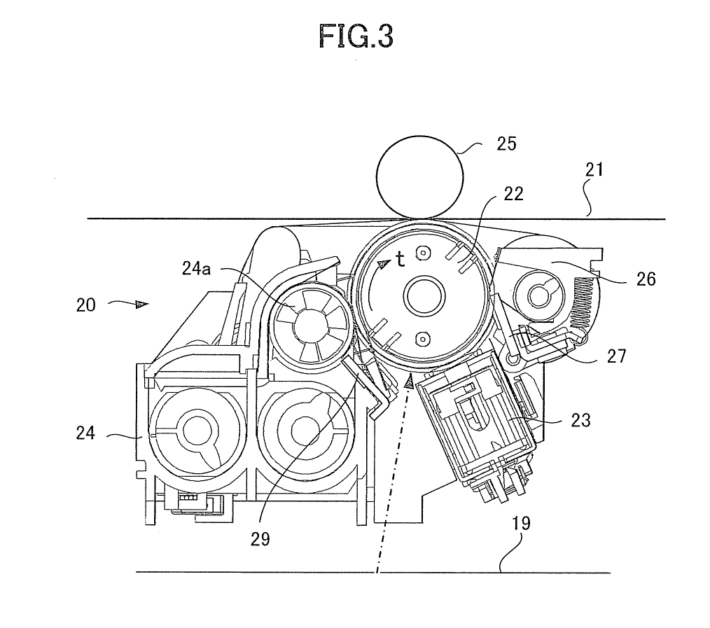

FIG. 3 is an enlarged view showing the configuration of one of the image forming units 20Y to 20K. Since the image forming units 20Y to 20K have the same configuration, the reference symbols Y, M, C and K are omitted in the following description. In FIG. 3, the charger 23, the developing unit 24, the primary transfer roller 25, the cleaner 26, the blade 27 and the like are arranged along the direction of rotation t, around the photoconductive drum 22. A laser beam from the optical scanning device 19 is cast to the exposure position on the photoconductive drum 22, and a latent image is formed on the photoconductive drum 22.

The charger 23 uniformly charges the entire surface of the photoconductive drum 22, for example, approximately to −700V. The developing unit 24 supplies a two-component developer containing a toner of each color and a carrier to the photoconductive drum 22, by the developing roller 24a to which a developing bias of approximately −500 V is applied. The developing roller 24a includes plural magnets at fixed positions, and a sleeve that is supported rotatably on the outer circumference of the magnets. The cleaner 26 uses the blade 27 to remove the residual toner on the surface of the photoconductive drum 22.

A regulating member 29 which regulates the thickness of a developer layer is provided facing the developing roller 24a. The regulating member 29 extends parallel to the axial direction of the developing roller 24a and is arranged at preset spacing from the surface of the developing roller 24a. The regulating member 29 regulates the thickness of the developer layer on the surface of the developing roller 24a in order to prevent the developer layer from becoming too thick.

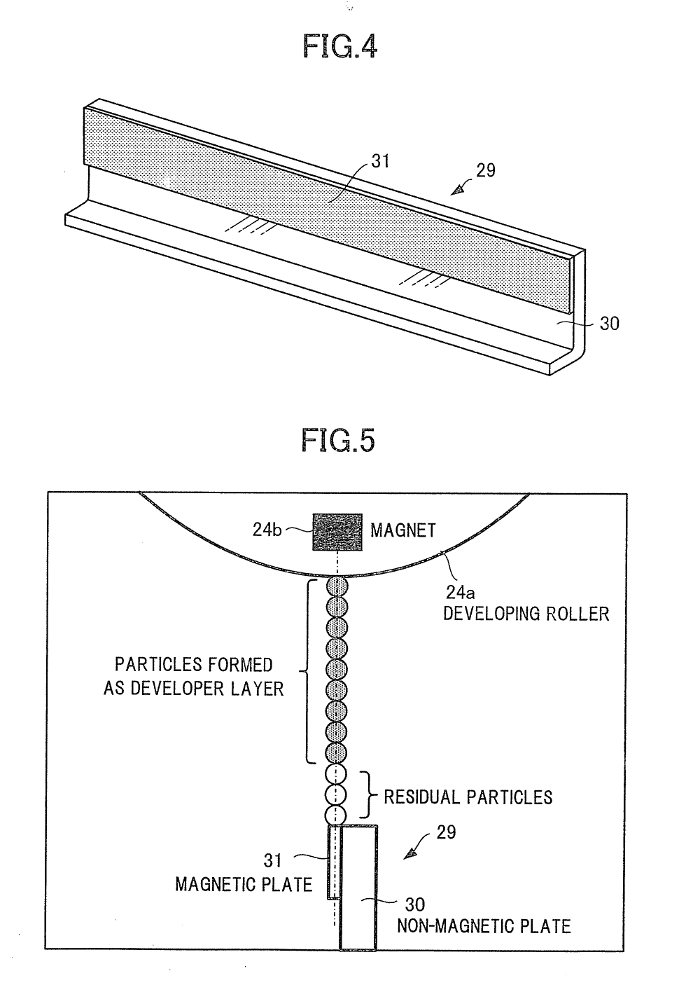

FIG. 4 is a perspective view schematically showing the shape of the regulating member 29. As shown in FIG. 4, the regulating member 29 includes a magnetic plate 31 attached to a non-magnetic plate 30. The regulating member 29 shown in FIG. 4 is described as a reference example.

FIG. 5 is an explanatory view showing the regulation of the thickness of the developer layer by the regulating member 29. As shown in FIG. 5, plural magnets forming magnetic poles are provided in the developing roller 24a (in FIG. 5, only a magnet 24b is shown). A magnetic chain is formed between the magnet 24b and the regulating member 29.

The two-component developer containing the magnetic carrier and the non-magnetic toner passes through the gap between the developing roller 24a and the regulating member 29 as the developing roller 24a rotates. The quantity of the developer that passes downstream in the direction of rotation of the developing roller 24a changes depending on the width of the gap. In FIG. 5, particles formed as the developer layer (shown in black) and residual particles (shown in white) are shown in different colors. That is, a particle layer, having a certain height that is decided on the basis of the balance between the rotating force of the developing roller 24a and the strength of the magnetic chain, moves downstream and forms a developer layer.

In an embodiment, in order to prevent a phenomenon of the developer layer becoming thick at a central part in the longitudinal direction of the developing roller 24a, the configuration of the regulating member 29 is improved so that the magnetic chain by the regulating member 29 is strengthened at the central part in the longitudinal direction. As the magnetic chain is strengthened at the central part in the longitudinal direction, the particles (developer layer) cannot easily pass downstream in the direction of rotation of the developing roller 24a via the gap. At both end parts in the longitudinal direction, the magnetic chain by the regulating member 29 is weakened so that the particles (developer layer) can easily pass downstream in the direction of rotation of the developing roller 24a.

Hereinafter, some examples of the configuration of the regulating member 29 will be described.

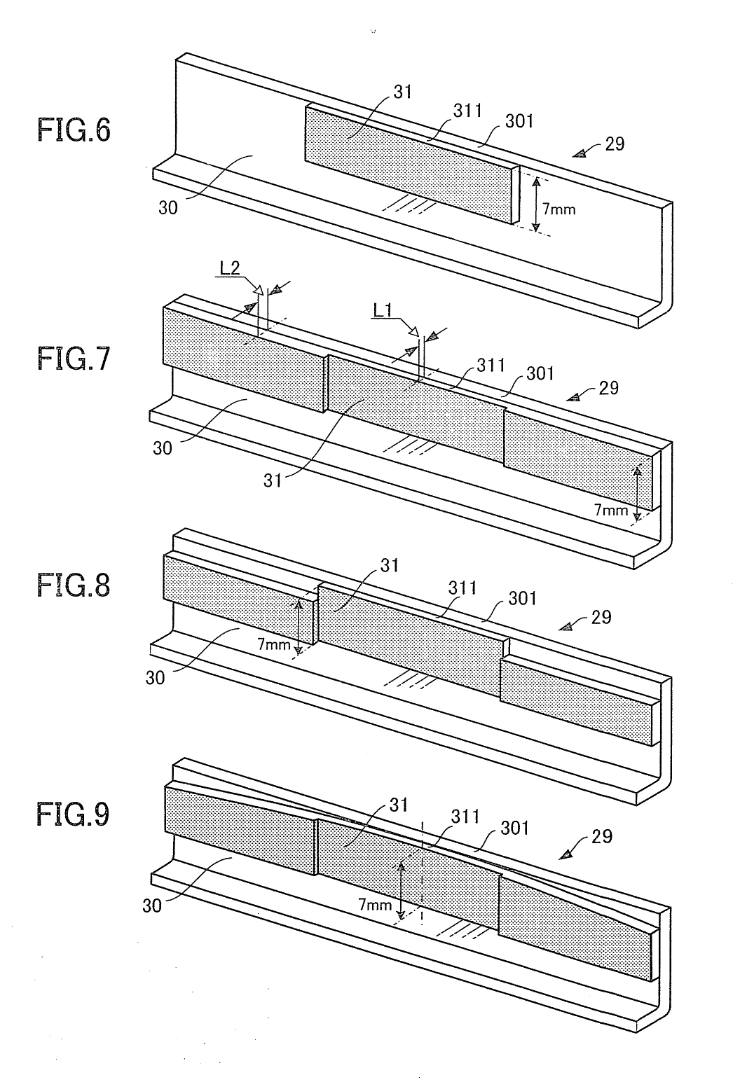

FIG. 6 is a perspective view showing a first configuration of the regulating member 29. The regulating member 29 includes the non-magnetic plate 30 which is L-shaped and the magnetic plate 31 attached to a side in the longitudinal direction of the non-magnetic plate 30. The longitudinal direction of the non-magnetic plate 30 is arranged parallel to the axial direction of the developing roller 24a.

The magnetic plate 31 is rectangular and is attached only at a central part in the longitudinal direction of the non-magnetic plate 30. No magnetic plate is attached to either end part of the non-magnetic plate 30. The magnetic plate 31 is attached to the non-magnetic plate 30 at plural points by spot welding. Alternatively, the magnetic plate 31 may be attached to the non-magnetic plate with an adhesive. An end surface 301 of the non-magnetic plate 30 faces the surface of the developing roller 24a.

An end surface 311 of the magnetic plate 31 which approaches the developing roller 24a is flush with the end surface 301 of the non-magnetic plate 30. Alternatively, the end surface 311 of the magnetic plate 31 is on the inner side from the end surface 301 so as not to protrude from the end surface 301 of the non-magnetic plate 30.

When the end surface 311 of the magnetic plate 31 is flush with the end surface 301 of the non-magnetic plate 30, the distance L0 (FIG. 5) between the two end surfaces 301 and 311 facing the surface in the direction of rotation of the developing roller 24a becomes longer. And confirmed by a past experiment that as the distance L0 becomes longer, robustness (which will be described later) of the thickness of the developer layer against changes in the surface state of the developing roller 24a can be secured. The distal end can be abraded in order to make the end surface 311 of the magnetic plate 31 flush with the end surface 301 of the non-magnetic plate 30. In the example shown in FIG. 6, the non-magnetic plate 30 has, for example, a thickness of 2 mm. The magnetic plate 31 has a thickness of 0.4 mm and a height of 7 mm.

FIG. 7 is a perspective view showing a second configuration of the regulating member 29. In FIG. 7, the magnetic plate 31 is attached to a side in the longitudinal direction of the non-magnetic plate 30. The magnetic plate 31 is rectangular. A central part and both end parts of the magnetic plate 31 in the longitudinal direction approach the developing roller 24a. The thickness of the central part in the longitudinal direction of the magnetic plate 31 is thinner than the thickness of both end parts. That is, when the thickness of the central part in the longitudinal direction of the magnetic plate 31 is expressed by L1 and the thickness of both end parts is expressed by L2, L1<L2 holds.

In the case of the magnetic plate 31 shown in FIG. 7, too, the end surface 311 approaching the developing roller 24a is flush with the end surface 301 of the non-magnetic plate 30. Alternatively, the end surface 311 of the magnetic plate 31 is on the inner side from the end surface 301 of the non-magnetic plate 30. In the example shown in FIG. 7, the non-magnetic plate 30 has, for example, a thickness of 2 mm. The magnetic plate 31 has the thickness L1 of 0.4 mm at the central part and the thickness L2 of 1 mm at both end parts, and a height of 7 mm.

FIG. 8 is a perspective view showing a third configuration of the regulating member 29. In FIG. 8, the magnetic plate 31 which has a step-like shape is attached to the non-magnetic plate 30. That is, a central part in the longitudinal direction of the magnetic plate 31 approaches the developing roller 24a and both end parts in the longitudinal direction are lowered in a step-like shape and thus away from the developing roller 24a.

In the case of the magnetic plate 31 shown in FIG. 8, too, the end surface 311 approaching the developing roller 24a is flush with the end surface 301 of the non-magnetic plate 30. Alternatively, the end surface 311 of the magnetic plate 31 is on the inner side from the end surface 301 of the non-magnetic plate 30. The thickness of the central part in the longitudinal direction of the magnetic plate 31 is thinner than the thickness of both end parts. In the example shown in FIG. 8, the non-magnetic plate 30 has, for example, a thickness of 2 mm. The magnetic plate 31 has a thickness of 0.4 mm at the central part and a thickness of 1 mm at both end parts, and a height of 7 mm at the central part.

FIG. 9 is a perspective view showing a fourth configuration of the regulating member 29. In FIG. 9, the regulating member 29 includes the magnetic plate 31 attached to a side in the longitudinal direction of the non-magnetic plate 30. The magnetic plate 31 has an arc-like end surface so that the central part in the longitudinal direction approaches the developing roller 24a most, with the distance from the developing roller 24a gradually increasing toward both end parts in the longitudinal direction.

The end surface 311 of the central part in the longitudinal direction of the magnetic plate 31 is flush with the end surface 301 of the non-magnetic plate 30. Alternatively, the end surface 311 of the magnetic plate 31 is on the inner side from the end surface 301 of the non-magnetic plate 30. The thickness of the central part in the longitudinal direction of the magnetic plate 31 is thinner than the thickness of both end parts. In the example shown in FIG. 9, the non-magnetic plate 30 has, for example, a thickness of 2 mm. The magnetic plate 31 has a thickness of 0.4 mm at the central part and a thickness of 1 mm at both end parts, and a height of 7 mm at the central part.

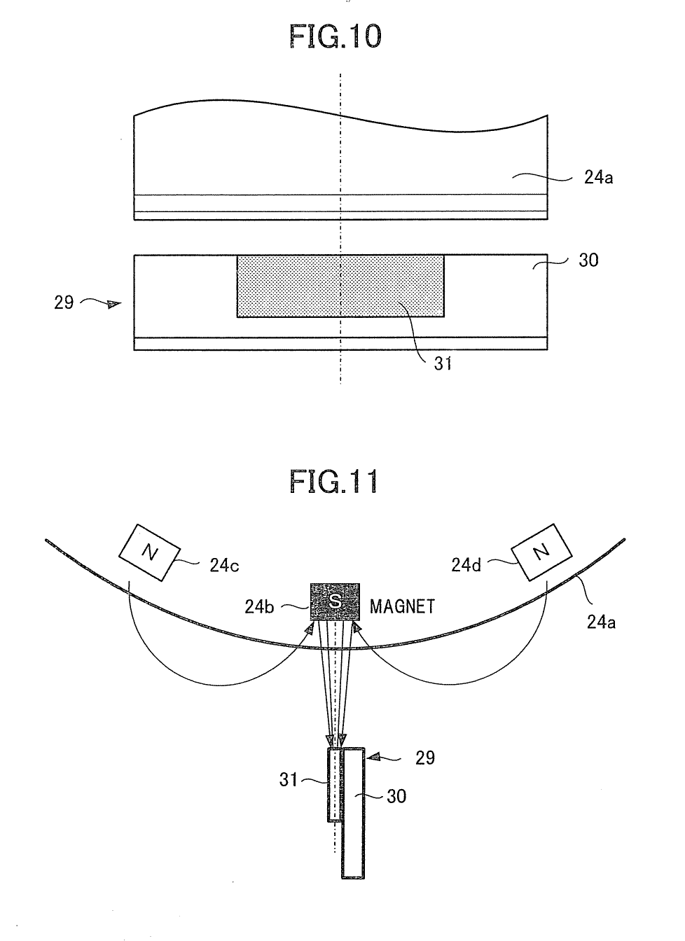

FIG. 10 shows the regulating member 29 shown in FIG. 6 and the developing roller 24a, as viewed from the front along the longitudinal direction. The regulating member 29 is arranged at a preset distance from the surface of the developing roller 24a, forming a gap between the distal end of the regulating member 29 and the surface of the developing roller 24a. The magnetic plate 31 of the regulating member 29 is attached only to the central part in the longitudinal direction of the non-magnetic plate 30 and therefore faces the central part in the axial direction of the developing roller 24a.

With the regulating member 29 shown in FIG. 6, the magnetic chain formed between the regulating member 29 and the developing roller 24a becomes stronger at the central part in the longitudinal direction and particles (developer layer) cannot easily pass downstream in the direction of rotation of the developing roller 24a. Meanwhile, at both end parts in the longitudinal direction, the magnetic plate 31 does not exist. Therefore, the magnetic chain becomes weaker and particles (developer layer) can easily pass downstream in the direction of rotation of the developing roller 24a.

Therefore, as the developing roller 24a rotates, the central part of the regulating member 29 is pushed by the developer and flexes. Thus, even when many particles of the developer are to pass, the strong magnetic chain at the central part makes difficult for the developer particles to pass and a developer layer that is uniform across the central part and both end parts can be formed.

When the end surface of the magnetic plate 31 is flush with the end surface of the non-magnetic plate 30 at the central part in the longitudinal direction of the regulating member 29, the distance LO (FIG. 5) between the two end surfaces 301 and 311 facing the surface in the direction of rotation of the developing roller 24a becomes longer. Therefore, good robustness of the thickness of the developer layer against changes in the surface state of the developing roller 24a is provided.

Robustness refers to property change that occurs when there is a disturbance. For example, robustness deteriorates when the quantity of the passing developer exceeds an allowable quantity as the gap width is changed. And confirmed by an experiment that robustness deteriorates in the structure where the end surface of the magnetic plate 31 protrudes from the end surface of the non-magnetic plate 30.

With the regulating member 29 shown in FIG. 7, the magnetic chain formed between the regulating member 29 and the developing roller 24a becomes stronger at the central part in the longitudinal direction because the thickness L1 of the central part in the longitudinal direction of the magnetic plate 31 is thinner than the thickness L2 of both end parts.

FIG. 11 is a side view showing the strength of the magnetic chain in the case where the thickness L1 of the central part in the longitudinal direction of the magnetic plate 31 is thinner. Plural magnets 24b, 24c, 24d and the like which form magnetic poles are arranged within the developing roller 24a, and the distribution of magnetic fluxes is indicated by arrows. When the thickness of the magnetic plate 31 is thin, lines of magnetic force from the magnet 24b concentrate on the magnetic plate 31 and therefore developer particles cannot easily pass through the gap.

Meanwhile, when the thickness L2 of the magnetic plate 31 is thick, lines of magnetic force from the magnet 24b are dispersed instead of concentrating on the magnetic plate 31 and therefore developer particles can easily pass through the gap. Therefore, with the regulating member 29 shown in FIG. 7, the magnetic chain formed between the regulating member 29 and the developing roller 24a is stronger at the central part in the longitudinal direction and weaker at both end parts.

Similarly, in the regulating members 29 shown in FIG. 8 and FIG. 9, the thickness of the central part in the longitudinal direction of the magnetic plate 31 is thinner than the thickness of both end parts. Both end parts in the longitudinal direction of the magnetic plate 31 are shaped to become away from the surface of the developing roller 24a. Therefore, the magnetic chain formed between the regulating member 29 and the developing roller 24a is stronger at the central part in the longitudinal direction and weaker at both end parts.

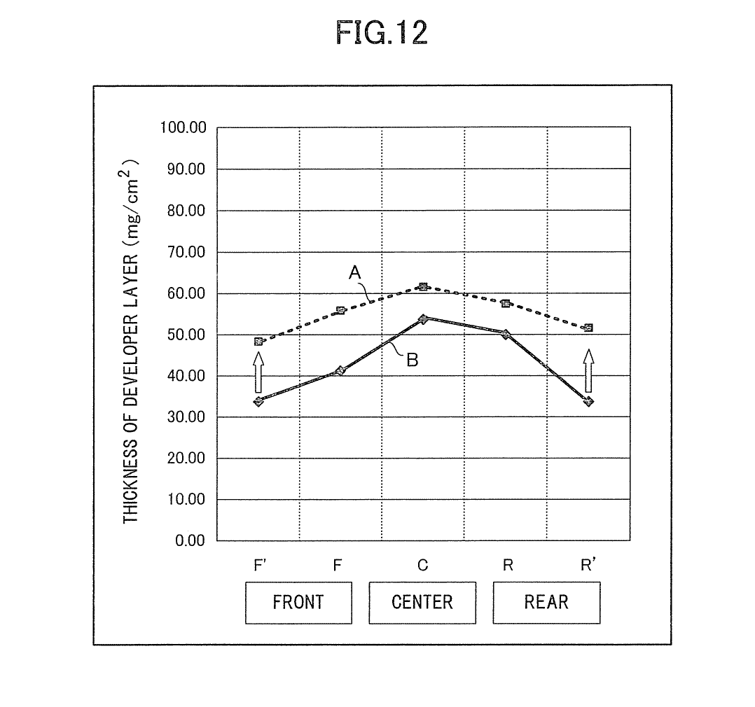

FIG. 12 shows the result of an experiment where the thickness of the regulating member 29 is changed. The vertical axis in FIG. 12 shows the thickness of the developer layer and the horizontal axis shows the position (front, center, rear) in the longitudinal direction of the regulating member 29. “Front” and “rear” refer to the front side and the rear side of the image forming apparatus 100.

FIG. 12 shows a graph in which the dotted line represents a characteristic A acquired when the thickness over the entire length in the longitudinal direction of the magnetic plate 31 is 1.0 mm and the position of the distal end of the magnetic plate 31 is withdrawn by 0.3 mm from the distal end of the non-magnetic plate 30. Also, in the graph, the solid line represents a characteristic B acquired when the thickness f the magnetic plate 31 is 0.6 mm over the entire length and the distal end of the magnetic plate 31 is flush with the distal end of the non-magnetic plate 30, as in the reference regulating member 29 shown in FIG. 4.

As can be seen from the characteristic A, when the thickness of the magnetic plate 31 is thick and its distance from the developing roller 24a is long, the thickness of the developer layer is increased over the entire length in the longitudinal direction of the developing roller 24a. Also, as can be seen from the characteristic B, when the thickness of the magnetic plate 31 is thin, the thickness of the developer layer is reduced over the entire length in the longitudinal direction of the developing roller 24a.

That is, as the thickness of the magnetic plate 31 is reduced, the magnetic force concentrates and the magnetic curtain by the regulating member 29 becomes stronger, and considered that the quantity of particles that shifts downstream in the direction of rotation as the developing roller 24a rotates is reduced. Therefore, it can be understood that the layer thickness regulating force is enhanced when the thickness of the magnetic plate 31 is reduced.

In the example of experiment shown in FIG. 12, since the same thickness is employed over the entire length in the longitudinal direction of the magnetic plate 31, there is a difference in the thickness of the developer layer between the central part and both end parts. However, when the thickness of both end parts of the magnetic plate 31 is made thicker than the thickness of the central part as shown in FIG. 7, the thickness of the developer layer can be increased at both end parts as indicated by the arrows and the thickness of the developer layer can be made substantially uniform at the central part and both end parts.

In the above embodiment, a uniform developer layer can be formed on the developing roller by the regulating member 29 and an image of good quality can be formed.

While certain embodiments have been described, these embodiments have been presented by way of example only, and are not intended to limit the scope of the invention. Indeed, the novel devices, apparatus and methods described herein may be embodied in a variety of other forms; furthermore, various omissions, substitutions and changes in the form of the devices, apparatus and methods described herein may be made without departing from the spirit of the inventions. The accompanying claims and their equivalents are intended to cover such forms or modifications as would fall within the scope and spirit of the inventions.

What is claimed is:

1. A developing device comprising:
a rotatable developing roller which has plural magnets forming magnetic poles; and
a regulating member which includes a non-magnetic plate and a magnetic plate extending parallel to an axial direction of the developing roller and arranged facing the developing roller to regulate thickness of a developer layer on the developing roller, the magnetic plate being attached to a central part in the longitudinal direction of the non-magnetic plate to form a magnetic chain between the developing roller and the regulating member stronger at the central part than an end part.

2. The device of claim 1, wherein an end surface that approaches the developing roller of the magnetic plate of the regulating member is flush with an end surface of the non-magnetic plate.

3. The device of claim 1, wherein an end surface that approaches the developing roller of the magnetic plate of the regulating member is on the inner side from an end surface of the non-magnetic plate.

4. A developing device comprising:
a rotatable developing roller which has plural magnets forming magnetic poles; and
a regulating member which includes a non-magnetic plate and a magnetic plate extending parallel to an axial direction of the developing roller and arranged facing the developing roller to regulate thickness of a developer layer on the developing roller, the magnetic plate has a thickness thinner at a central part in a longitudinal direction of the magnetic plate than at both end parts to form a magnetic chain between the developing roller and the regulating member stronger at the central part than the both end parts.

5. The device of claim 4, wherein an end surface that approaches the developing roller of the magnetic plate of the regulating member is flush with an end surface of the non-magnetic plate.

6. The device of claim 4, wherein an end surface that approaches the developing roller of the magnetic plate of the regulating member is on the inner side from an end surface of the non-magnetic plate.

7. The device of claim 4, wherein the magnetic plate of the regulating member has a step-like shape so that the central part in the longitudinal direction approaches a surface of the developing roller and both end parts are away from the surface of the developing roller.

8. The device of claim 4, wherein the magnetic plate of the regulating member has an arc-like end surface so that the central part in the longitudinal direction approaches a surface of the developing roller most and the distance from the surface of the developing roller increases toward both end parts.

9. A developing method comprising:
supplying a developer to an image carrier by a rotatable developing roller which has plural magnets forming magnetic poles; and
regulating thickness of a layer of the developer on the developing roller by a regulating member which includes a non-magnetic plate and a magnetic plate extending parallel to an axial direction of the developing roller and arranged facing the developing roller; and
the magnetic plate being attached to a central part in the longitudinal direction of the non-magnetic plate to form a magnetic chain between the developing roller and the regulating member stronger at the central part than an end part.

10. The method of claim 9, wherein an end surface that approaches the developing roller of the magnetic plate of the regulating member is flush with an end surface of the non-magnetic plate.

11. The method of claim 9, wherein an end surface that approaches the developing roller of the magnetic plate of the regulating member is on the inner side from an end surface of the non-magnetic plate.

12. A developing method comprising:
supplying a developer to an image carrier by a rotatable developing roller which has plural magnets forming magnetic poles; and
regulating thickness of a layer of the developer on the developing roller by a regulating member which includes a non-magnetic plate and a magnetic plate extending parallel to an axial direction of the developing roller and arranged facing the developing roller;
the magnetic plate has a thickness thinner at a central part in a longitudinal direction of the magnetic plate than at both end parts to form a magnetic chain between the developing roller and the regulating member stronger at the central part than the both end parts.

13. The method of claim 12, wherein an end surface that approaches the developing roller of the magnetic plate of the regulating member is flush with an end surface of the non-magnetic plate.

14. The method of claim 12, wherein an end surface that approaches the developing roller of the magnetic plate of the regulating member is on the inner side from an end surface of the non-magnetic plate.

15. The method of claim 12, wherein the magnetic plate of the regulating member is configured in such a manner that the central part in the longitudinal direction approaches a surface of the developing roller and both end parts are away from the surface of the developing roller.

16. An image forming apparatus comprising:
an image carrier which is irradiated with a laser beam and thus has an electrostatic latent image formed thereon;
a developing unit which includes a rotatable developing roller having plural magnets forming magnetic poles, and supplies a developer to the image carrier;
a regulating member which includes a non-magnetic plate and a magnetic plate extending parallel to an axial direction of the developing roller and arranged facing the developing roller to regulate thickness of a developer layer on the developing roller, the magnetic plate being attached to a central part in the longitudinal direction of the non-magnetic plate to form a magnetic chain between the developing roller and the regulating member stronger at the central part than an end part; and
a transfer unit which transfers a toner image formed on the image carrier by the developing unit to a sheet.

17. The apparatus of claim 16, wherein an end surface that approaches the developing roller of the magnetic plate of the regulating member is flush with an end surface of the non-magnetic plate or is on the inner side from the end surface of the non-magnetic plate.

18. An image forming apparatus comprising:
an image carrier which is irradiated with a laser beam and thus has an electrostatic latent image formed thereon;
a developing unit which includes a rotatable developing roller having plural magnets forming magnetic poles, and supplies a developer to the image carrier; a regulating member which includes a non-magnetic plate and a magnetic plate extending parallel to an axial direction of the developing roller and arranged facing the developing roller to regulate thickness of a developer layer on the developing roller, the magnetic plate has a thickness thinner at a central part in a longitudinal direction of the magnetic plate than at both end parts to form a magnetic chain between the developing roller and the regulating member stronger at the central part than the both end parts; and
a transfer unit which transfers a toner image formed on the image carrier by the developing unit to a sheet.

19. The apparatus of claim 18, wherein an end surface that approaches the developing roller of the magnetic plate of the regulating member is flush with an end surface of the non-magnetic plate or is on the inner side from the end surface of the non-magnetic plate.

20. The apparatus of claim 18, wherein the magnetic plate of the regulating member is configured in such a manner that the central part in the longitudinal direction approaches a surface of the developing roller and both end parts are away from the surface of the developing roller.
